(19) United States
(12) Patent Application Publication
(10) Pub. No.: US 2026/0321254 A1
(43) Pub. Date: Oct. 15, 2026

(54) SERVICE PROVISION SYSTEM USING ROBOT AND METHOD THEREOF

(71) Applicants: HYUNDAI MOTOR COMPANY, Seoul (KR); Kia Corporation, Seoul (KR)

(72) Inventors: Hyun Sik CHOI, Hwaseong-si (KR); Eui Hyeok LEE, Hwaseong-si (KR); Ho Geon YU, Hwaseong-si (KR)

(21) Appl. No.: 19/291,529

(22) Filed: Aug. 5, 2025

(30) Foreign Application Priority Data
Apr. 10, 2025 (KR) 10-2025-0046949

(51) Int. Cl. G10L 15/22; G05D 1/2285; G05D 1/69; G05D 101/00; G05D 109/10; G05D 111/30; G10L 15/08; G10L 15/10; G10L 15/18; G10L 15/26; G10L 21/0208

(52) U.S. Cl. CPC G10L 15/22; G05D 1/2285; G05D 1/69; G10L 15/10; G10L 15/18; G10L 15/26; G10L 21/0208; G05D 2101/22; G05D 2109/10; G05D 2111/32; G10L 2015/088; G10L 2015/223

(57) ABSTRACT

A service provision system includes a plurality of robots connected to a cloud network, wherein each of the robots includes a processor. The processor includes a keyword spotting module that detects a specified keyword in a voice command of a speaker, a keyword processing module that estimates a speech distance from the speaker to the robot in which the processor is included based on the detected keyword, and a speech processing module that identifies an intention associated with the voice command based on the voice command of the speaker. The processor performs a service related to the identified intention.

### CROSS-REFERENCE TO RELATED APPLICATION

This application claims the benefit of priority to Korean Patent Application No. 10-2025-0046949, filed in the Korean Intellectual Property Office on Apr. 10, 2025, the entire contents of which are incorporated herein by reference.

### TECHNICAL FIELD

The present disclosure relates to a service provision system for controlling a robot and a method thereof, and more particularly, to a technology for selecting, from among a plurality of robots, a robot that satisfies optimal conditions in response to a service request from a client (user/speaker).

### BACKGROUND

In recent years, artificial intelligence systems have been used in various fields. As an artificial intelligence system has become more widely adopted, the recognition performance has improved, making it possible to understand user preferences more accurately. Accordingly, existing rule-based smart systems have been gradually replaced by artificial intelligence systems based on deep learning. Artificial intelligence technology includes machine learning (e.g., deep learning) and various component technologies that leverage machine learning. Such technology is applied across a wide range of domains, with representative examples including language understanding and motion control. Language understanding refers to technology for recognizing and processing human language and characters, and may include natural language processing, machine translation, conversational systems, question answering, speech recognition/synthesis, and the like. Motion control refers to technology for controlling autonomous driving and robot movement, and may include movement control (e.g., navigation, collision, driving), manipulation control (e.g., action control), and the like.

Recently, various services have been provided using voice recognition devices equipped with artificial intelligence agents that provide answers to user voice inquiries. A user may activate the voice recognition function of a voice recognition device through a trigger word. The voice recognition functionality has evolved to be embedded in robots, enabling them to provide a series of services in response to voice commands.

These artificial intelligence technologies or artificial intelligence agents collaborate with robots to help them automate difficult tasks or repetitive operations. As a result, robots are increasingly being deployed to replace or assist humans in a variety of settings.

Recently, various studies have been conducted on technologies for calling robots. In general, when a person orders a robot to perform a task, the command is transmitted to the robot by using a wireless control device or by operating a button installed externally on the robot. In this case, when calling the robot wirelessly, radio frequency (RF) signals and infrared signals may be used. However, conventional robot-calling technologies are limited in that the user must possess a device equipped with a specific communication module (e.g., for RF or infrared), which may cause inconvenience from a user experience perspective.

A more advanced approach has been proposed in which a robot receives a voice command and performs a corresponding function. In this approach, the robot recognizes voices commands issued at a service locations, interprets the commands using voice recognition, and provides corresponding feedback. For example, a service robot may extract keywords from sentences spoken by a user and perform a set of motions corresponding to the extracted keywords.

However, when a plurality of robots exists in a shared space, voice-based technology may have limitations due to simultaneous responses from multiple robots that recognize voice commands. In addition, in environments where a plurality of robots have different capabilities, each robot may require different call commands. In such cases, there is an inevitable cost associated with developing individual call commands for each robot, and a challenge arises in delivering an integrated, unified service experience across multiple robots.

### SUMMARY

The present disclosure is directed to a service provision system for controlling a robot and a method thereof capable of calling the optimal robot to provide a service in response to a client request in a situation where a plurality of robots exist in a shared space.

The present disclosure is also directed to a service provision system for controlling a robot and a method thereof capable of allowing the robot closest to a client among a plurality of robots to provide a service in response to a call.

The present disclosure is also directed to a service provision system for controlling a robot and a method thereof capable of allowing a robot capable of actually providing a service among a plurality of robots to provide a service in response to a call.

According to one aspect of the present disclosure, a service provision system for controlling a robot can include a plurality of robots connected to a cloud network and each including a processor, where the processor includes a keyword spotting module configured to detect a specified keyword in a voice command of a speaker, a keyword processing module configured to, based on the detected keyword, estimate a speech distance from the speaker to the robot in which the processor is included, and a speech processing module configured to, based on the voice command of the speaker, identify an intention associated with the voice command. The processor can be configured to perform a service related to the identified intention.

In some implementations, the processor can be configured to, based on the estimated speech distance to the robot is the shortest among the plurality of robots or the voice command from the speaker corresponding to a service executable by the robot, control the robot to perform the service. In some implementations, the keyword processing module can include a feature extraction device configured to extract one or more features of log-mel, a generalized cross correlation (GCC), a sound pressure level (SPL), or a mel-frequency cepstral coefficient (MFCC) to thereby generate an embedding vector, and an attention device configured to perform a first matrix multiplication and scaling on a query and a key, perform a softmax operation, and perform a second matrix multiplication on a value subjected to the softmax operation and a value of the embedding vector after output values from a plurality of scale-external attention blocks are connected, and a query, the key, and a value input through a linear layer pass through the linear layer. The keyword processing module can be configured to estimate the speech distance between the speaker and the robot.

In some examples, the feature extraction device can be configured to generate a weight matrix by multiplying a weight by the extracted features, reshape an inner product of the feature and the weight through the linear layer, and calculate a cosine similarity to generate the embedding vector. In some examples, the feature extraction device can be configured to generate the weight by training in advance according to each distance between the speaker and the robot, generate a feature matrix for the log-mel, the GCC, the SPL, and the MFCC, update the weight to allow an inner product of the feature matrix and a weight inner product to be an identity matrix, and generate the weight by using a concatenate function.

In some implementations, the speech processing module can include an automatic speech recognition (ASR) device configured to convert the voice command of the speaker into text data to generate the embedding vector, a natural language understanding (NLU) device configured to analyze the embedding vector to identify the intention of the speaker, and a machine reading comprehension (MRC) device configured to interpret the identified intention of the speaker and transmit the intention to the processor. In some examples, the speech processing module can be configured to rank frequently used embedding vectors by assigning weights to the frequently used embedding vectors.

In some implementations, the processor can be configured to assign a higher weight to a case in which the voice command from the speaker corresponds to a service executable by the robot, compared to a case in which the estimated speech distance to the robot is the shortest. In some implementations, the service provision system can further include a noise removal module configured to remove noise included in the voice command of the speaker. In some implementations, the processor can be configured to calculate an estimated value by sizing the voice command to a sample size of 1024×10 and applying a weight based on the speech distance and an intention result of the speaker, and determine a robot to be connected by re-applying the weight to the estimated value.

According to another aspect of the present disclosure, a method of providing a service by controlling a robot among a plurality of robots connected to a cloud network can include detecting a specified keyword in a voice command of a speaker, estimating a speech distance from the speaker to a corresponding robot based on the detected keyword, identifying, based on the voice command of the speaker, an intention associated with the voice command of the speaker, and performing a service related to the identified intention.

In some implementations, performing the service can include performing, based on the estimated speech distance to the robot is the shortest among the plurality of robots or the voice command from the speaker corresponding to a service executable by the robot, the service. In some implementations, estimating the speech distance can include extracting one or more features of log-mel, a generalized cross correlation (GCC), a sound pressure level (SPL), or a mel-frequency cepstral coefficient (MFCC) to thereby generate an embedding vector, and performing a first matrix multiplication and scaling on a query and a key, performing a softmax operation, and performing a second matrix multiplication on a value subjected to the softmax operation and a value of the embedding vector after output values from a plurality of scale-external attention blocks are connected, and a query, the key, and a value input through a linear layer pass through the linear layer. The speech distance between the speaker and the robot can be estimated.

In some examples, extracting the features can include generating a weight matrix by multiplying a weight by the extracted features, reshaping an inner product of the feature and the weight through the linear layer, and calculating a cosine similarity to generate the embedding vector. In some examples, extracting the features can further include generating the weight by training in advance according to each distance between the speaker and the robot, generating a feature matrix for the log-mel, the GCC, the SPL, and the MFCC, updating the weight to allow the feature matrix and a weight inner product to be an identity matrix, and generating the weight by using a concatenate function.

In some implementations, identifying the intention can include generating the embedding vector by converting the voice command of the speaker into text data, analyzing the embedding vector to identify the intention of the speaker, and interpreting the identified intention of the speaker and transmitting the intention. In some examples, generating the embedding vector can include ranking frequently used embedding vectors by assigning weights to the frequently used embedding vectors.

In some implementations, performing the service can include assigning a higher weight to a case in which the voice command from the speaker corresponds to a service executable by the robot, compared to a case in which the estimated speech distance to the robot is the shortest. In some implementations, the method can further include removing noise included in the voice command of the speaker. In some implementations, controlling the robot can include calculating an estimated value by sizing the voice command to a sample size of 1024×10 and applying a weight based on the speech distance and an intention result of the speaker, and determining a robot to be connected by re-applying the weight to the estimated value.

### BRIEF DESCRIPTION OF THE DRAWINGS

FIG. 1 is a diagram illustrating an example of a service provision system.

FIG. 2 is a block diagram illustrating an example of a robot.

FIG. 3 is a block diagram illustrating an example of a processor for controlling a robot operation.

FIG. 4 is a diagram illustrating an example of securing a keyword section.

FIG. 5 is a diagram illustrating an example of the keyword processing module of FIG. 3.

FIG. 6 is a diagram illustrating an example of generating weights by estimating a weight matrix for each distance.

FIG. 7 is a diagram illustrating the configuration of an speech processing module of FIG. 3;

FIG. 8 is a diagram illustrating an example of a process of assigning a weight to a specific robot by the speech processing module of FIG. 7.

FIG. 9 is a flowchart illustrating an example of a method of providing service using a robot.

FIGS. 10 and 11 are diagrams illustrating an example of a state in which a specific robot is selected and operates when a voice command of a speaker occurs.

FIG. 12 is a block diagram illustrating an example of a computing system.

### DETAILED DESCRIPTION

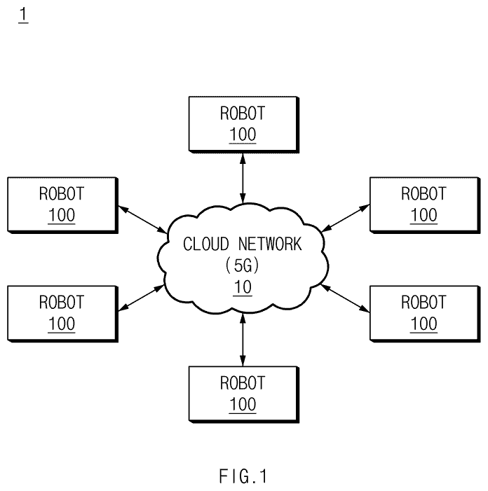

FIG. 1 is a diagram illustrating an example of a service provision system.

Referring to FIG. 1, a system 1 can include at least two robots 100 connected to a cloud network 10. The robots 100 connected to the cloud network 10 can communicate with each other. The cloud network 10 can refer to a network that constitutes part of a cloud computing infrastructure or exists within the cloud computing infrastructure. In some implementations, the cloud network 10 can be configured using a 3G network, a 4G or a long term evolution (LTE) network, or a 5G network.

In FIG. 1, the system can further include a server. The server can refer to a device that trains an artificial neural network using a machine learning algorithm or uses a trained artificial neural network.

An artificial neural network, which is a model used in machine learning, can refer to a model with a problem-solving capability that includes artificial neurons (nodes) that form a network by combining synapses. The artificial neural network can be defined by connection patterns between neurons in different layers, a learning process that updates model parameters, and an activation function that generates output values.

An artificial neural network can include an input layer, an output layer, and optionally one or more hidden layers. Each layer can include one or more neurons, and the artificial neural network can include synapses connecting neurons. In an artificial neural network, each neuron can output a function value of an activation function for input signals, weights, and biases received through synapses.

In addition, the server can include a plurality of servers to perform distributed processing. The robots 100 can communicate with each other through a server, but as mentioned, they may also communicate directly with each other without the assistance of a server.

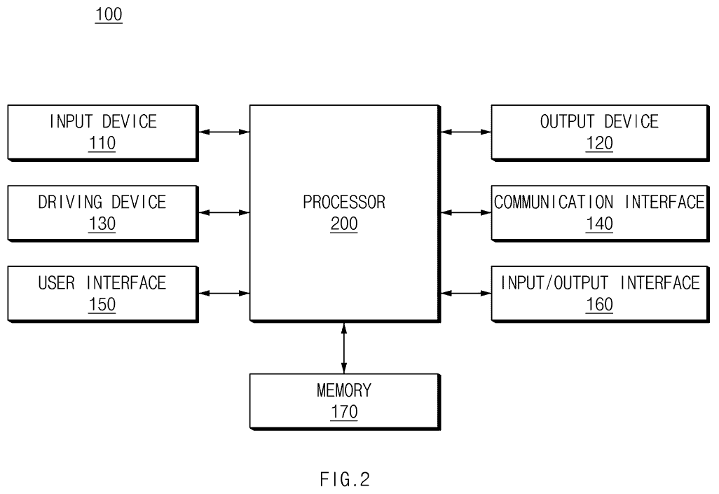

FIG. 2 is a block diagram illustrating an example of a robot.

In some implementations, a robot can refer to a machine that automatically processes or operates a given task by its own abilities. A robot can refer to devices that move along a given path without the control of a speaker, or that move by determining its own path. In particular, a robot that has functions of recognizing an environment, making decisions on its own, and performing operations can refer to an intelligent robot.

A robot can include a guide robot, a transport robot, a cleaning robot, a wearable robot, an entertainment robot, a pet robot, an unmanned aerial robot, and the like, and such a robot can be a robot that provide a specified service in a specific environment.

The robot can include a robot control module for controlling movements. The robot control module can refer to a software module or a chip that implements the software as a hardware module.

The robot can obtain status information of the robot, detect or recognize the surrounding environment and objects, generate map data, determine a movement path and driving plan, determine a response to user interaction, or determine an operation by using sensor information obtained from various types of sensors. In some implementations, the robot can use sensor information obtained from at least one sensor among a lidar, a radar, or a camera to determine a movement path and driving plan.

The robot can perform operations or drive by controlling a driving device based on the control/interaction of a speaker. In some implementations, the robot can obtain information regarding the intention of the interaction according to the actions or voice utterances of a speaker, and perform the operation by determining a response based on the obtained intention information.

Referring to FIG. 2, the robot 100 can include an input device 110, an output device 120, a driving device 130, a communication interface 140, a user interface 150, an input/output interface 160, a memory 170, and a processor 200.

In some implementations, the input device 110 can obtain various types of data. The input device 110 can include a camera for inputting a video signal, a microphone for receiving an audio signal, a user input device for receiving information from a speaker, and the like. The input device 110 can obtain input data to be used when obtaining output using learning data and a learning model for model learning, and can also obtain unprocessed input data.

In some implementations, the input device 110 can include a microphone. The microphone can obtain a voice command from a speaker. One or more microphones can be mounted on a main body of the robot 100.

In some implementations, the output device 120 can generate outputs related to vision, hearing, or touch. The output device 120 can include a display device that outputs visual information, a speaker that outputs auditory information, a haptic module that outputs tactile information, and the like. In this case, the speaker can output a voice message. For example, the speaker can output a voice message corresponding to a sentence introducing a robot.

In some implementations, the driving device 130 is configured to perform various motions of the robot 100. For example, the driving device 130 can include a wheel that moves the robot 100 in a specified direction according to a voice command of a speaker, and a wheel driving motor that rotates the wheel. In addition or alternatively, the driving device 130 can include a motor for moving the head, arm, or hand of a robot. The driving device 130 can include a motor driving circuit that supplies driving current to various motors and a rotation detection sensor that detects the rotational displacement and rotational speed of a motor.

In some implementations, the communication interface 140 can include at least one circuit and communicate with various types of external devices. For example, the communication interface 140 can communicate with another robot. The communication interface 140 can include at least one of a Bluetooth low energy (BLE) module, a Wi-Fi communication module, a cellular communication module, a 3rd generation (3G) mobile communication module, a 4th generation (3G) mobile communication module, a 4th generation long term evolution (LTE) communication module, or a 5th generation (5G) mobile communication module.

In some implementations, the user interface 150 can be implemented as a device such as a button, a touch pad, a mouse, and a keyboard, or as a touch screen capable of performing the display function and operation input function described above. In this case, the button can include various types of buttons, such as a mechanical button, a touch pad, a wheel, and the like, formed on an area of the front, side, or back of the main body of the robot 100.

In some implementations, the input/output interface 160 can be one of a high definition multimedia interface (HDMI), a mobile high-definition link (MHL), a universal serial bus (USB), a display port (DP), a thunderbolt, a video graphics array (VGA) port, an RGB port, a D-subminiature (D-SUB), and a digital visual interface (DVI). The input/output interface 160 can input/output at least one of audio or video signals. Depending on the implementation manner, the input/output interface 160 can include a port that inputs/outputs only audio signals and a port that inputs/outputs only video signals as separate ports, or can be implemented as a single port that inputs/outputs both audio signals and video signals.

In some implementations, the memory 170 can store an operating system (OS) for controlling the overall operation of components of the robot 100 and commands or data related to components of the robot 100. For example, the memory 170 can store a sentence database in which sentences to be spoken by the robot 100 to the speaker are stored, or a motion database in which information about motions to be performed by the robot 100 is stored. The sentence database can store information about tokens constituting sentences and texts corresponding to sentences. For a sentence to which a motion is assigned, the motion identification information can be stored together with the sentence while being matched with the sentence. The motion database can store information about a motion. The information about a motion can include rotation angles for each axis corresponding to each component (e.g., head) of the robot 100. For example, the rotation angles can include angles corresponding to each of the roll axis, the pitch axis, and the yaw axis.

In this case, the memory 170 can store data required for the module controlling the operation of the robot 100 to perform various operations.

The memory 170 can be implemented as a non-volatile memory (e.g., a hard disk, a solid state drive (SSD), or a flash memory), a volatile memory, and the like.

In some implementations, the processor 200 can be electrically connected to the memory 170 to control the overall function and operation of the robot 100. The processor 200 can control the operation of the robot 100 based on the voice command of a speaker obtained through a microphone.

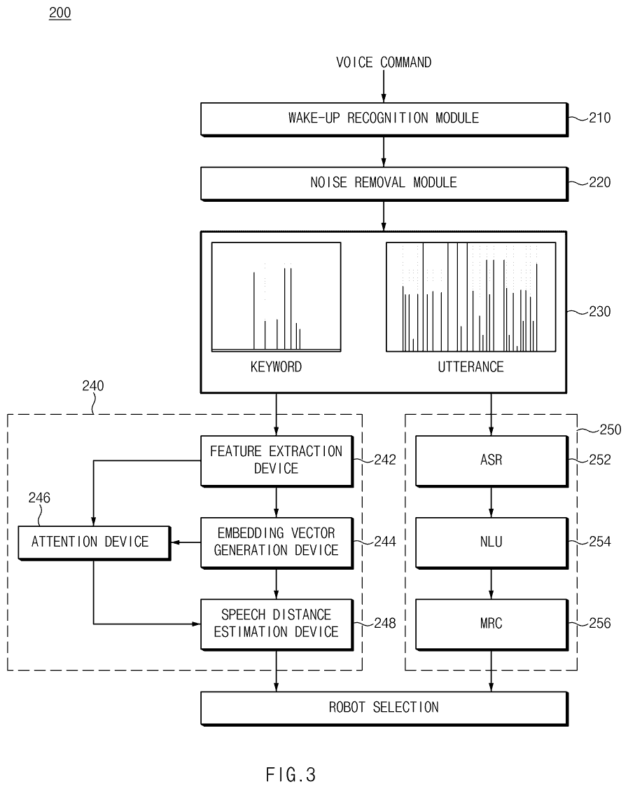

In some implementations, the processor 200 can include the configurations of devices, modules, and the like described in FIG. 3 below, and, in this case, the processor 200 can include two or more sub-processors for each function. In addition, each of the configurations below is illustrated separately, which may mean that they are configured individually and independently in terms of hardware, but they may also be designed and provided as one so that one or more processors operate in terms of software.

In some implementations, the robot 100 can include a sensor or a camera, depending on the implementation manner.

The sensor can obtain status information of the robot 100, detect or recognize the surrounding environment and objects, generate map data, determine a movement path and driving plan, determine a response to an interaction with a speaker, or determine an action.

The camera can obtain images of the surroundings of the robot 100. The camera can include various image sensors. For example, the camera can include at least one of a complementary metal oxide semiconductor (CMOS) image sensor or a charge coupled device (CCD) image sensor.

FIG. 3 is a block diagram illustrating an example of a processor for controlling a robot operation.

Referring to FIG. 3, the processor 200 can include a wake-up recognition module 210, a noise removal module 220, a keyword spotting module 230, a keyword processing module 240, and a speech processing module 250. These modules 210, 220, 230, 240 and 250 can be modules for processing keyword sections and utterance sections obtained from the voice command of a speaker, respectively. Thus, the speaker can select the robot closest to him or herself or a robot capable of providing an actual service, and receive a series of services from the selected robot.

In some implementations, the wake-up recognition module 210 can recognize a voice command from a speaker through the input device 110, and, when the voice command is received, can activate the robot 100 to receive the input of the speaker. Before recognizing the voice command, the robot 100 can be in a standby state or a sleep state.

In some implementations, the noise removal module 220 can remove echo and various noises that can be included in a microphone input signal when a voice command is uttered. The noise removal module 220 can remove sounds other than voice as noise as needed.

In some implementations, the keyword spotting (KWS) module 230 can detect only a specified keyword in a voice command of a speaker by using a voice recognition technology based on keyword spotting. The keyword spotting can be a scheme of detecting whether a specific keyword is uttered while continuously monitoring the voice of a speaker. When a keyword is detected, the keyword spotting module 230 can roll back a specified section from a time point at which the keyword is detected, thereby securing only a keyword section.

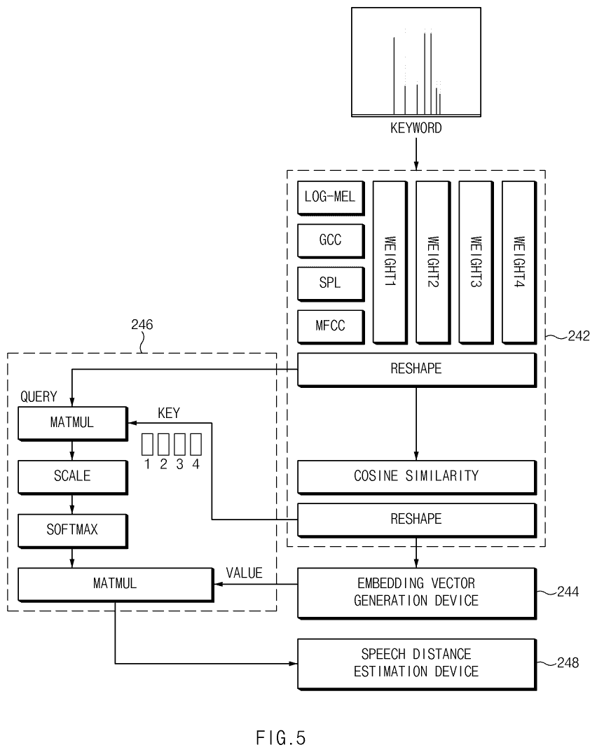

In some implementations, the keyword processing module 240 can estimate the distance between the robot 100 and a speaker. To this end, the keyword processing module 240 can include a feature extraction device 242, an embedding vector generation device 244, an attention device 246, a speech distance estimation device 248, and the like. The details will be described below with reference to FIG. 5.

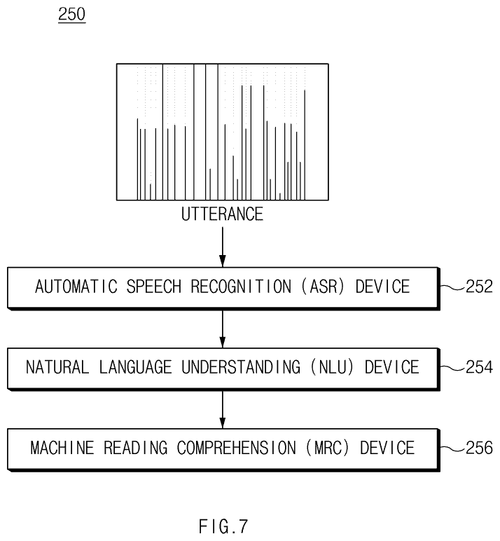

In some implementations, the speech processing module 250 can identify the intention of a speaker included in a voice command. To this end, the speech processing module 250 can include an automatic speech recognition (ASR) device 252, a natural language understanding (NLU) device 254, a machine reading comprehension (MRC) device 256, and the like. The details will be described below with reference to FIG. 7.

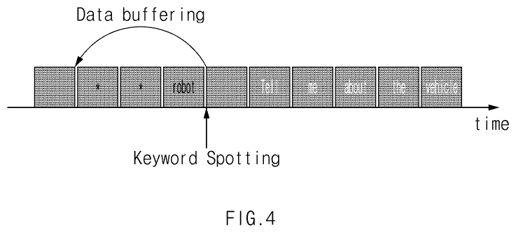

FIG. 4 is a diagram illustrating an example of securing a keyword section.

As shown in FIG. 4, when “** robot” is detected as a keyword, data buffering can be rolled back to secure a keyword section.

In some implementations, a keyword spotting section and a speech verification section can be distinguished in a voice command based on the detection result of the keyword spotting module 230.

FIG. 5 is a diagram illustrating an example of the keyword processing module of FIG. 3.

Referring to FIG. 5, the keyword processing module 240 can include the feature extraction device 242, the embedding vector generation device 244, the attention device 246, the speech distance estimation device 248, and the like.

In some implementations, the feature extraction device 242 can extract an embedding vector. The embedding vector can reflect voice features well and is for convenient calculation. In some implementations, features such as log-mel, a generalized cross correlation (GCC), a sound pressure level (SPL), and a mel-frequency cepstral coefficient (MFCC) can be extracted.

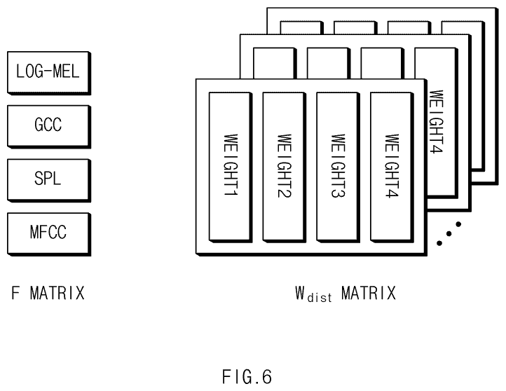

The feature extraction device 242 can multiply the extracted features by weights to generate a matrix, reshape the inner product of the extracted features and weights through a linear layer, and then extract an embedding vector by calculating cosine similarity. In this case, the weights can be generated by pre-training it by distance. The details will be described below with reference to FIG. 6.

In some implementations, the embedding vector generation device 244 can generate an embedding vector through the extracted embedding vector. The generated embedding vector can be transferred to the attention device 246.

In some implementations, the attention device 246 can perform parallel operations on matrices that divide each of the input query (Q), key (K) and value (V) into a specified number (num_Heads) through a specified number of scaled dot-product attention blocks.

For example, the attention device 246 concatenates output values from each of a plurality of scaled dot-product attention blocks, passes them through a linear layer, and then receives a query (Q), a key (K), and a value (V). Then, among them, the query and key can be processed by matrix multiplication (MatMul) and scaling, and then softmax operation can be performed. Then, the value processed by the softmax operation can again be processed by matrix multiplication (MatMul) with the embedding vector value. The calculated value can be an speech distance value.

The speech distance estimation device 248 can estimate the speech distance between the robot and the speaker by using the output speech distance value.

FIG. 6 is a diagram illustrating an example of generating weights by estimating a weight matrix for each distance.

Referring to FIG. 6, for example, the distance between the robot 100 and the speaker can be set in advance to 0.5 m, 1 m, 1.5 m, 2 m, 3 m, and 5 m, and feature matrixes for the log-mel, generalized cross correlation (GCC), sound pressure level (SPL) and mel-frequency cepstral coefficient (MFCC) can be generated for keyword sections at each distance (F Matrix).

Then, the weights can be updated such that the inner product of the feature matrix and the weight becomes the identity matrix (W_{dist.}Matrix).

This process can be performed for each set distance (F*W_{dist.}=d×I_{dist}′, where ‘d’ represents a distance), and the weight matrix obtained through the process can be used to generate weights by using the concatenate function as following Equation 1.

W_{dist.}=d×F⁻¹*I_{dist.} [Equation 1]

Where ‘d’ represents a distance.

FIG. 7 is a diagram illustrating an example of an speech processing module of FIG. 3.

Referring to FIG. 7, the speech processing module 250 can include the automatic speech recognition (ASR) device 252, the natural language understanding (NLU) device 254, and the machine reading comprehension (MRC) device 256.

In some implementations, the automatic speech recognition device 252 can convert a voice command of a speaker into text data. The automatic speech recognition device 252 can include a speech recognition function.

The speech recognition function can include an acoustic model and a language model. For example, the acoustic model can include information related to vocalization, and the language model can include information about unit phoneme information and combinations of unit phoneme information. The speech recognition function can convert user speech into text data by using information related to vocalization and information about unit phonemes.

In some implementations, the natural language understanding device 254 can perform syntactic analysis or semantic analysis to determine the intention of a speaker. The syntactic analysis can divide the speaker's input into syntactic units (e.g., words, phrases, morphemes, and the like) and determine what syntactic elements the divided units have. The semantic analysis can be performed using semantic matching, rule matching, formula matching, and the like.

In this case, the natural language understanding device 254 can determine the intention and parameters of a speaker by using a matching rule divided into a domain, an intention, and a parameter necessary to understand the intention.

In addition, the natural language understanding device 254 can use linguistic features (e.g., syntactic elements) such as morphemes, phrases, and the like to identify the meaning of words extracted from the voice command of a speaker, and can match the identified meaning of words to the domain and intention to determine the intention of the speaker. For example, the natural language understanding device 254 can determine the intention of a speaker by calculating how many words extracted from the input of the speaker are included in each domain and intention.

In addition, the natural language understanding device 254 can determine the parameters of a speaker input by using the words that serve as the basis for understanding the intention.

In addition, the natural language understanding device 254 can determine the intention of a speaker by using a natural language recognition database in which linguistic features for understanding the intention of a speaker are stored.

In particular, in some implementations, the natural language understanding device 254 can prioritize frequently used vectors by assigning weights to them. This can improve the processing speed of the MRC 256 at the rear.

In some implementations, the machine reading comprehension device 256 can provide text corresponding to the voice command of a speaker to the processor 200. The machine reading comprehension device 256 can refer to a machine reading model that reads and interprets a series of documents and manuals based on an artificial intelligence (AI) algorithm. For example, the machine reading comprehension device 256 can analyze documents by using a natural language processing (NLP) algorithm trained based on various types of deep learning such as a recurrent neural network (RNN), a convolution neural network (CNN), and the like.

Furthermore, the machine reading comprehension device 256 can be a model that reads and interprets a document, and then searches for text (e.g., an answer corresponding to a question) corresponding to the speaker's input (e.g., the question) based on the corresponding document.

In addition, the machine reading comprehension device 256 can be a model trained using a transformer-based neural network in addition to recurrent and convolution.

In addition, the machine reading comprehension device 256 can include a question generation (QG) model that obtains questions by performing NLP based on multiple sentences and a question answer (QA) model that obtains answers corresponding to the obtained questions. In this case, the QG model included in the machine reading comprehension device 256 can obtain a keyword of the corresponding sentence included in the manual based on the sentences included in the manual, and then the machine reading comprehension device 256 can obtain the best form of question among multiple questions capable of being generated from the corresponding sentence. In addition, the GA model can identify the sentence as the answer corresponding to the question obtained.

The speech processing module of FIG. 7 having such a configuration can identify the relationship between a context and a query and provide an answer.

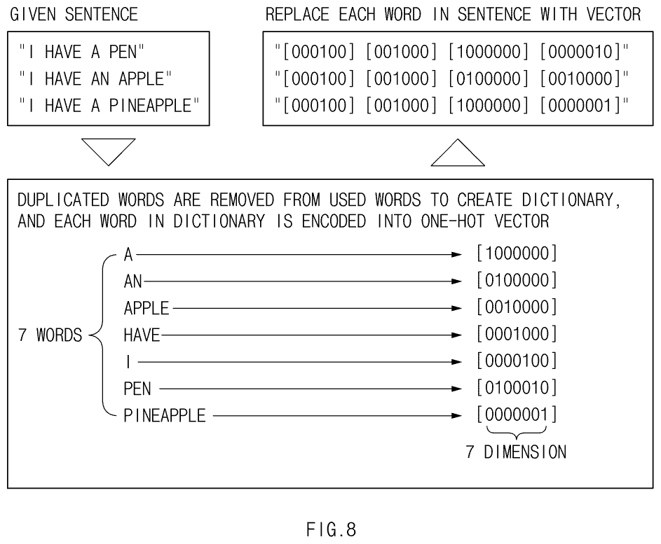

In some implementations, when a voice command of a speaker is input, the speech processing module 250 can quantify text information by using speech-to-text (STT) and assign a high weight to an appropriate robot for the function requested by the speaker through word embedding. An example thereof will be described below with reference to FIG. 8.

FIG. 8 is a diagram illustrating an example of a process of assigning a weight to a specific robot by the speech processing module of FIG. 7.

Referring to FIG. 8, when there are three sentences such as ‘I have a pen’, ‘I have an apple’, and ‘I have a pineapple’, the duplicated words can be removed from used words to create a dictionary, and each word in the dictionary can be encoded into a one-hot vector.

In detail, seven words (a, an, apple, have, i, pen, and pineapple) can be extracted from the three sentences, and, when encoding each of these seven words into a one-hot vector, ‘a’ can be expressed as [1000000], ‘an’ as [0100000], ‘apple’ as [0010000], ‘have’ as [0001000], ‘i’ as [0000100], ‘pen’ as [0000010], and ‘pineapple’ as [0000001].

Then, a vector can be generated that represents only the index of each word in the sentence as ‘1’.

For example, in the sentence, ‘I have an apple’ may be expressed as [0000100], [0001000], [0100000], [0010000].

Through such a process, it is possible to cluster words with similar similarities, and as a result, it is possible to determine which robot is the optimal robot for the voice command of a speaker. That is, a high weight can be assigned to a robot appropriate to perform the voice command well.

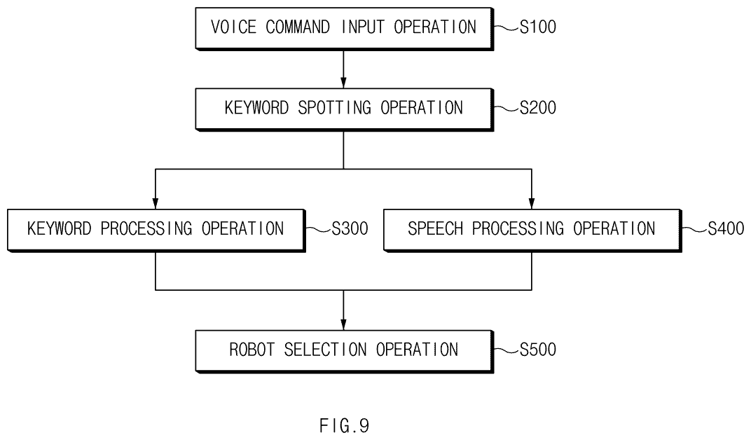

FIG. 9 is a flowchart illustrating an example of a method of providing service using a robot.

Referring to FIG. 9, a method of providing a service using a robot can include a voice command input operation S100, a keyword spotting operation S200, a keyword processing operation S300, a speech processing operation S400, and a robot selection operation S500. In this case, each of the operations can be performed by being combined with another operation, or one operation can be performed by being divided into two or more operations. In addition, not all of the operations may be necessarily required, and one or more operations may be omitted or other operations may be added depending on the method of providing a service.

In addition, it should be noted that the keyword processing operation S300 and the speech processing operation S400 can be performed simultaneously for an input voice command.

In the voice command input operation S100, a microphone mounted on the robot 100 can receive a voice command from a speaker.

When a voice command is input, the processor 200 can recognize it as a wake-up command, and, according to the wake-up command, the robot 100 can change from a sleep or standby mode to an active mode. The active mode can refer to a mode in which the robot 100 is capable of immediately performing a specified operation or function according to the voice command. In addition, when a voice command is input, the processor 200 can control the noise removal module 220 to remove noise or ambient noise that may be included in the voice command.

In the keyword spotting operation S200, the keyword spotting module 230 can detect only a specified keyword in the voice command of a speaker by using a keyword spotting-based speech recognition technology. For example, keyword spotting can refer to an operation of recognizing a keyword for problem solving from natural language. In addition, keyword spotting is to detect only a specified keyword in continuously input voice signals.

In the keyword spotting operation S200, whether a specific keyword is spoken can be detected while continuously monitoring the voice of the speaker. When a keyword is detected, the keyword spotting module 230 can roll back a specified section from a time point when the keyword is detected, thereby securing only the keyword section. Through such a process, it is possible to distinguish between the keyword spotting section and the speech verification section.

In some implementations, a specific robot can be selected through values provided based on the results of the keyword spotting section and the speech verification section.

In the keyword processing operation S300, the distance between each robot 100 and the speaker can be estimated in the keyword spotting section. In the keyword processing operation S300, estimation of the distances between all robots placed in a specified space and the speaker can be performed simultaneously and in parallel. That is, the distances from the speaker, which may be different for each robot 100, can be estimated.

In the keyword processing operation S300, first, the feature extraction device 242 can extract features such as log-mel, a generalized cross correlation (GCC), a sound pressure level (SPL), and a mel-frequency cepstral coefficient (MFCC). Then, the extracted features can be multiplied by weights to generate a matrix, and the inner product of the features and weights can be reshaped through a linear layer, and then the cosine similarity can be calculated to extract an embedding vector. In this case, the weights can be generated by pre-training them by distance.

Then, the attention device 246 can use the feature as a query (Q) and the cosine similarity value as a key (K) to perform matrix multiplication (MatMul) and scaling, and softmax operations. Thereafter, the value processed by the softmax operation and the embedding vector value can again be multiplied by the matrix operation (MatMul). Through such an operating process, the distance between each robot and the speaker can be estimated and provided.

In the speech verification section, the speech processing operation S400 can be performed in the order of automatic speech recognition, natural language understanding, and machine reading understanding.

The automatic speech recognition in the speech processing operation S400 can convert the voice command of a speaker into text data.

Then, the natural language understanding can be used to identify and determine the intention of a speaker's input. In this case, weights can be assigned to vectors frequently used in the natural language understanding operation and their priorities can be determined. Such priorities can vary depending on the type of robot 100, the location where the robot 100 is arranged, the environment, and the like. For example, in places such as restaurants, because voice commands related to menu orders, and the like may occur relatively more frequently than other commands, the robot 100 can provide voice commands such as menu orders by prioritizing them. Ranking frequently used vectors like this may improve the speed of the service that processes the voice command.

Then, machine reading understanding can provide the processor with text corresponding to the voice command of the speaker.

In the robot selection operation S500, a specific robot can be selected based on the keyword processing operation S300 in the keyword spotting section and the speech processing operation S400 in the speech verification section. Then, the selected robot can perform a specified function.

That is, the speech distance calculated in the keyword processing operation S300 for the voice command of the speaker and the intention of the speaker identified in the speech processing operation S400 can be shared between all robots 100 through the cloud network 10. Accordingly, all robots can determine the speech distance or the intention of the speaker, and a robot that meets a specified condition can be selected to provide the service.

In some implementations, the priority of the speech distance and the intention of the speaker can be determined. For example, a robot that is able to immediately perform a service in response to the intention of the speaker can be given a higher weight than the speech distance. Therefore, even when the robot is slightly further away than the speaker, when there is a robot nearby that is able to immediately provide the service, the robot can be finally selected to provide the service.

However, in some implementations, it is possible to change the priority of the speech distance and the intention of a speaker. That is, the priority can vary depending on the service target or space, and, when the priority is reversed, the robot with the closest speech distance can be selected first when a voice command is generated.

In some implementations, it is possible to control a robot by selecting only one of a keyword spotting section and a speech verification section. That is, a robot can be selected by only checking the speech distance, or a robot that is able to provide a specific service can be selected. In this case, only the components that check the speech distance or determine the intention of a speaker may operate, and the remaining components may be in a standby or sleep state.

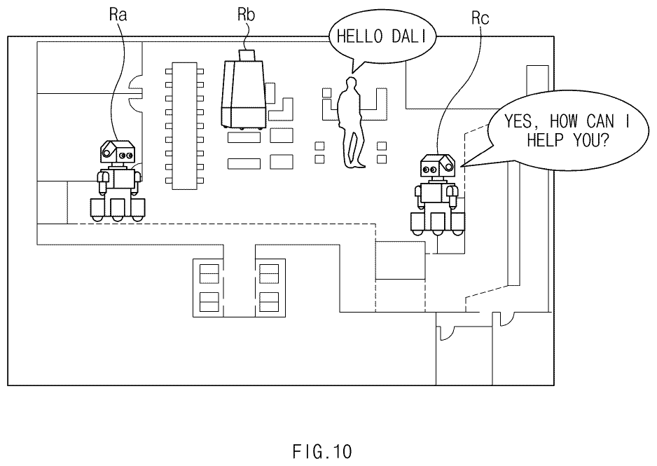

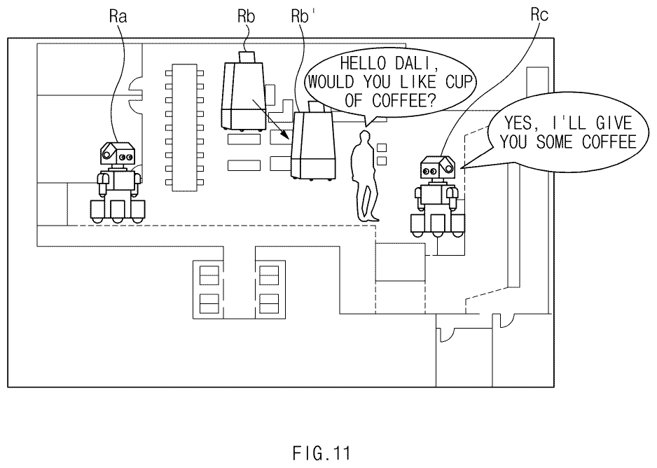

FIGS. 10 and 11 are diagrams illustrating an example of a state in which a specific robot is selected and operates when a voice command of a speaker occurs.

Referring to FIG. 10, when a plurality of robots Ra, Rb and Rc are arranged in a specified space and a speaker gives a voice command, it may be understood that the robot Rc located closest to the speaker can respond and provide a series of services.

Referring to FIG. 11, the plurality of robots Ra, Rb and Rc are arranged in a specified space and a speaker gives a voice command. In this case, there is the robot Rc located close to the speaker, but there is the robot Rb that is able to actually provide a service at a relatively far distance from the robot Rc, and this is an example in which the robot Rb moves to a location Rb′ and provides a series of services to the speaker.

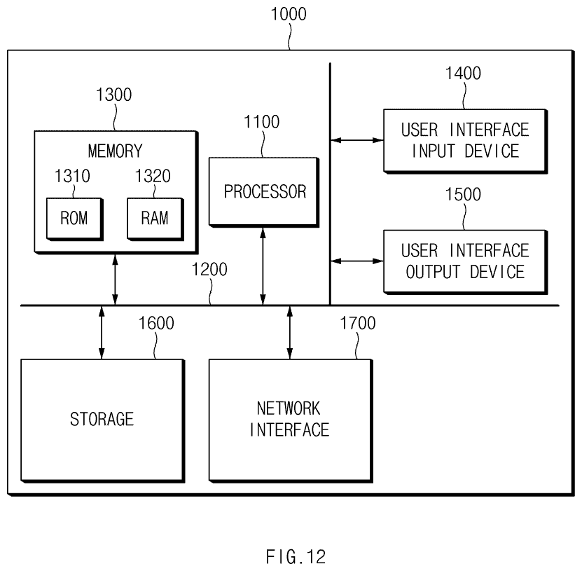

FIG. 12 is a block diagram illustrating an example of a computing system.

Referring to FIG. 12, a computing system 1000 can include at least one processor 1100, a memory 1300, a user interface input device 1400, a user interface output device 1500, storage 1600, and a network interface 1700 connected through a bus 1200.

The processor 1100 can be a central processing unit (CPU) or a semiconductor device that processes instructions stored in the memory 1300 and/or the storage 1600. The memory 1300 and the storage 1600 can include various volatile or nonvolatile storage media. For example, the memory 1300 can include a read only memory (ROM) and a random access memory (RAM).

Accordingly, the processes of the method or algorithm described in relation to the implementations of the present disclosure can be implemented by hardware executed by the processor 1100, a software module, or a combination thereof. The software module can reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM.

The exemplary storage medium can be coupled to the processor 1100, and the processor 1100 can read information from the storage medium and write information in the storage medium. In another method, the storage medium can be integrated with the processor 1100. The processor and the storage medium can reside in an application specific integrated circuit (ASIC). The ASIC can reside in a user terminal. In another method, the processor and the storage medium can reside in the user terminal as an individual component.

According to the present technology, even when a plurality of robots exists in a specific space, the closest robot or a robot that is able to actually provide a service may respond to the voice command of a speaker and provide a series of services corresponding to the voice command.

Therefore, even when a plurality of robots exists in one space, the robots may be operated individually.

In addition, because there is no need to use different voice commands for each robot, the time and cost of developing different voice commands to call each robot may be reduced.

What is claimed is:

1. A service provision system for controlling a robot, the service provision system comprising:
a plurality of robots connected to a cloud network and each including a processor,
wherein the processor includes:
a keyword spotting module configured to detect a specified keyword in a voice command of a speaker;
a keyword processing module configured to, based on the detected keyword, estimate a speech distance from the speaker to the robot in which the processor is included; and
a speech processing module configured to, based on the voice command of the speaker, identify an intention associated with the voice command, and
wherein the processor is configured to perform a service related to the identified intention.

2. The service provision system of claim 1, wherein the processor is configured to, based on the estimated speech distance to the robot is the shortest among the plurality of robots or the voice command from the speaker corresponding to a service executable by the robot, control the robot to perform the service.

3. The service provision system of claim 1, wherein the keyword processing module includes:
a feature extraction device configured to extract one or more features of log-mel, a generalized cross correlation (GCC), a sound pressure level (SPL), or a mel-frequency cepstral coefficient (MFCC) to thereby generate an embedding vector, and
an attention device configured to:
perform a first matrix multiplication and scaling on a query and a key,
perform a softmax operation, and
perform a second matrix multiplication on a value subjected to the softmax operation and a value of the embedding vector after output values from a plurality of scale-external attention blocks are connected, and a query, the key, and a value input through a linear layer pass through the linear layer, and
wherein the keyword processing module is configured to estimate the speech distance between the speaker and the robot.

4. The service provision system of claim 3, wherein the feature extraction device is configured to:
generate a weight matrix by multiplying a weight by the extracted features,
reshape an inner product of the feature and the weight through the linear layer, and
calculate a cosine similarity to generate the embedding vector.

5. The service provision system of claim 4, wherein the feature extraction device is configured to:
generate the weight by training in advance according to each distance between the speaker and the robot,
generate a feature matrix for the log-mel, the GCC, the SPL, and the MFCC,
update the weight to allow an inner product of the feature matrix and a weight inner product to be an identity matrix, and generate the weight by using a concatenate function.

6. The service provision system of claim 3, wherein the speech processing module includes:
an automatic speech recognition (ASR) device configured to convert the voice command of the speaker into text data to generate the embedding vector,
a natural language understanding (NLU) device configured to analyze the embedding vector to identify the intention of the speaker, and
a machine reading comprehension (MRC) device configured to interpret the identified intention of the speaker and transmit the intention to the processor.

7. The service provision system of claim 6, wherein the speech processing module is configured to rank frequently used embedding vectors by assigning weights to the frequently used embedding vectors.

8. The service provision system of claim 2, wherein the processor is configured to assign a higher weight to a case in which the voice command from the speaker corresponds to a service executable by the robot, compared to a case in which the estimated speech distance to the robot is the shortest.

9. The service provision system of claim 1, further comprising:
a noise removal module configured to remove noise included in the voice command of the speaker.

10. The service provision system of claim 1, wherein the processor is configured to:
calculate an estimated value by sizing the voice command to a sample size of 1024×10 and applying a weight based on the speech distance and an intention result of the speaker, and
determine a robot to be connected by re-applying the weight to the estimated value.

11. A method of providing a service by controlling a robot among a plurality of robots connected to a cloud network, the method comprising:
detecting a specified keyword in a voice command of a speaker;
estimating a speech distance from the speaker to a corresponding robot based on the detected keyword;
identifying, based on the voice command of the speaker, an intention associated with the voice command of the speaker; and
performing a service related to the identified intention.

12. The method of claim 11, wherein performing the service includes performing, based on the estimated speech distance to the robot is the shortest among the plurality of robots or the voice command from the speaker corresponding to a service executable by the robot, the service.

13. The method of claim 11, wherein estimating the speech distance includes:
extracting one or more features of log-mel, a generalized cross correlation (GCC), a sound pressure level (SPL), or a mel-frequency cepstral coefficient (MFCC) to thereby generate an embedding vector, and
performing a first matrix multiplication and scaling on a query and a key, perform a softmax operation, and performing a second matrix multiplication on a value subjected to the softmax operation and a value of the embedding vector after output values from a plurality of scale-external attention blocks are connected, and a query, the key, and a value input through a linear layer pass through the linear layer, and
wherein the speech distance between the speaker and the robot is estimated.

14. The method of claim 13, wherein extracting the features includes generating a weight matrix by multiplying a weight by the extracted features, reshaping an inner product of the feature and the weight through the linear layer, and calculating a cosine similarity to generate the embedding vector.

15. The method of claim 14, wherein extracting the features further includes generating the weight by training in advance according to each distance between the speaker and the robot, generating a feature matrix for the log-mel, the GCC, the SPL, and the MFCC, updating the weight to allow the feature matrix and a weight inner product to be an identity matrix, and generating the weight by using a concatenate function.

16. The method of claim 13, wherein identifying the intention includes:
generating the embedding vector by converting the voice command of the speaker into text data,
analyzing the embedding vector to identify the intention of the speaker, and
interpreting the identified intention of the speaker and transmitting the intention.

17. The method of claim 16, wherein generating the embedding vector includes ranking frequently used embedding vectors by assigning weights to the frequently used embedding vectors.

18. The method of claim 12, wherein performing the service includes assigning a higher weight to a case in which the voice command from the speaker corresponds to a service executable by the robot, compared to a case in which the estimated speech distance to the robot is the shortest.

19. The method of claim 11, further comprising:
removing noise included in the voice command of the speaker.

20. The method of claim 11, wherein controlling the robot includes:
calculating an estimated value by sizing the voice command to a sample size of 1024×10 and applying a weight based on the speech distance and an intention result of the speaker; and
determining a robot to be connected by re-applying the weight to the estimated value.
